(19) United States
(12) Patent Application Publication
(10) Pub. No.: US 2003/0054966 A1
(43) Pub. Date: Mar. 20, 2003

(54) Water soluble package and liquid contents thereof

(75) Inventors: Gavin Bone, Bebington (GB); Helene Sylvie Buron, Toulouse (FR); Craig Warren Jones, Bebington (GB); Laurent Soubiran, Bebington (GB)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/171,491

(22) Filed: Jun. 13, 2002

(30) Foreign Application Priority Data
Jun. 18, 2001 (GB) 0114850.1

(51) Int. Cl. C11D 17/00

(52) U.S. Cl. 510/296

(57) ABSTRACT

A water soluble package comprises a substantially non-aqueous liquid rinse conditioning composition therein, wherein the water soluble package comprises a polymeric film. A process for conditioning fabrics comprises the step of adding to the rinse cycle of a washing operation the water soluble package and rinse conditioning composition therein, allowing or causing the package to break so as to release the contents therefrom and contacting the composition with fabric being laundered. The package is either disposed in the drum at the beginning of the wash cycle, remains intact through the wash cycle and disperses and/or dissolves at the beginning of or during the rinse cycle or is disposed in the rinse compartment of the dispenser drawer or in the drum between the wash and rinse cycles and disperses and/or dissolves immediately.

### FIELD OF THE INVENTION

The present invention relates to a water soluble package for containing a rinse conditioner composition.

### BACKGROUND AND PRIOR ART

Rinse added fabric conditioning compositions are well known. Typically, such compositions comprise a liquid fabric softening agent which can be included at up to 6% by weight, in which case the compositions are considered dilute, from 6 to 10% by weight in which case the compositions are considered semi-dilute, from 10% to 22% by weight, in which case the compositions are considered concentrated and from 22 to 60% by weight in which case the compositions are considered superconcentrated.

Conventionally, rinse conditioning compositions are provided as a liquid in a plastics bottle which requires the consumer to dose the correct amount of the fabric softening composition from the bottle into the dispensing drawer of a washing machine.

The problem with conventional liquid fabric softeners provided in a bottle or other such package is that there is always a risk of underdosing or overdosing the rinse conditioning composition into the dispenser drawer of a washing machine resulting in a unsatisfactory or undesired level of softening being provided to fabrics. There is also the problem of spillage of the ingredients when pouring the product from the package into the dispensing drawer of a washing machine.

Therefore, it is desirable to provide a rinse conditioning composition which is convenient to use and guarantees that the correct amount of fabric softening composition is dosed into the rinse cycle. It is also desirable to avoid the problem of spillage of the product associated with the dispensing of conventional rinse conditioners from a bottle or the like.

Water soluble packages are known in the detergent and agrochemical industries and generally comprise either vertical form-fill-seal (VFFS) envelopes or thermoformed envelopes. In one of the VFFS processes, a roll of water soluble film is sealed along its edges to form a tube, which tube is heat sealed intermittently along its length to form individual envelopes which are filled with product and heat sealed. The thermoforming process generally involves moulding a first sheet of water soluble film to form one or more recesses adapted to retain a composition, such as for example a solid agrochemical composition, placing the composition in the at least one recess, placing a second sheet of water soluble material over the first so as to cover the or each recess, and heat sealing the first and second sheets together at least around the recesses so as to form one or more water soluble packages.

Cleaning products are traditionally often liquids, viscous or thin, such as known for personal cleaning (bath and shower liquids and shampoos) or for domestic cleaning (hand dish wash and other hard surface cleaning, laundry-cleaning etc.). Other products are solids, such as powders, granules, small capsules (up to 2 mm diameter) or more recently tablets, for laundry and machine dish wash, and soap bars for skin cleaning. Recently, so called unit dose products are experiencing an increasing success with consumers, because they eliminate the need for manipulating, and possibly spilling, liquids or powders and simplify the use of a correct dose of the product for the required purpose. Examples thereof are the laundry and machine dish wash tablets mentioned above and recently described in F. Schambil and M. Böcker, Tenside Surf.Det. 37 (2000) 1.

Many types of water soluble packages are known, including packages made from polyvinyl alcohol (hereinafter referred to as “PVOH”) film. A wide variety of different materials can be packaged in such films, including liquid materials. EP-A-518689 discloses a containerisation system for hazardous materials (for example pesticides) comprising a PVOH film enclosing a composition comprising the hazardous material, water, an electrolyte and optional other materials. The electrolyte is added to reduce the solubility of the film to prevent its dissolution by the packaged composition.

EP-B-389513 discloses concentrated aqueous syrups (mainly foodstuffs but other materials such as detergents are mentioned) inside PVOH packages, the concentration of the syrup being effective to prevent dissolution of the package by the packaged composition.

EP-A-700989 discloses a unit packaged detergent for dish washing, the package comprising a detergent composition wrapped in PVOH film, wherein the film protects the detergent from dissolution until the main wash cycle of the dish washing machine.

WO-A-97/27743 discloses an agrochemical composition packaged in a water soluble sachet, which can be PVOH.

GB-A-2118961 discloses bath preparations packaged in PVOH film, while EP-B-347221 relates to water-soluble sachets of phytosanitary materials which are packaged in a secondary water-insoluble pack with a humid environment being maintained between the two.

EP-A-593952 discloses a water soluble sachet of PVOH with two chambers and a treatment agent for washing inside each chamber.

EP-A-941939 relates to a water soluble package, which can be PVOH, containing a composition which, when dissolved, produces a solution of known composition.

GB-A-2305931 discloses a dissolvable laundry sachet and BE-9700361 relates to a water soluble unit-dosed cleaning agent, especially for cleaning hands.

DE-29801621 discloses a water soluble unit dose for dishwashing machines.

EP-B-160254 relates to a washing additive comprising a mixture of detergent constituents in a PVOH bag. The detergent comprises nonionic surfactant and a quaternary ammonium compound.

U.S. Pat. No. 4,846,992 discloses a double-packaged laundry detergent wherein the inner package is water-soluble and can be PVOH.

EP-B-158464 relates to a detergent mull packaged in PVOH and DE-A-19521140 discloses a water soluble PVOH sachet containing a detergent composition.

FR-2601930 relates to a water soluble sachet containing any substance, particularly a pharmaceutical.

A variety of water soluble PVOH films are also known. For example, EP-B-157162 relates to a self-supporting film comprising a PVOH matrix having rubbery microdomains dispersed therein.

WO-A-96/00251 relates to an amphipathic graft copolymer comprising a hydrophobic backbone with grafting sites to which are grafted a hydrophilic polymer prepared from a hydrophilic monomer containing stabilising pH independent ionic groups.

GB-B-2090603 relates to a water soluble film comprising a uniform mixture of partially hydrolysed polyvinyl acetate and polyacrylic acid.

WO-A-97/00282 relates to a water soluble film combining two polymeric ingredients S and H where S is a soft acid-functional olefinic addition copolymer having a Tg less than 20° C. and H is a hard acid-functional olefinic addition copolymer having a Tg less than 40° C. The ratio of S:H is from 90:10 to 65:35 and the acid functionalities are at least partially neutralised to render the film water soluble.

EP-B-79712 relates to a laundry additive for discharge to a wash containing borate ions. The additive is enclosed within a film of PVOH which is plasticised and has as a solubiliser either a polyhydroxy compound (such as sorbitol) or an acid (such as polyacrylic acid).

EP-B-291198 relates to a water soluble film containing an alkaline or borate-containing additive. The film is formed from a copolymer resin of vinyl alcohol having 0-10 mole % residual acetate groups and 1-6 mole % of a non-hydrolysable anionic comonomer. FR-2724388 discloses a water soluble bottle, flask or drum made from PVOH which is plasticised with 13-20% of plasticiser (such as glycerol) and then moulded.

The specifications of International Patent Applications WO-A-00/55044, WO-A-00/55045, WO-A-00/55046, WO-A-00/55068, WO-A-00/55069 and WO-A-00/55415 disclose water soluble packages containing a fluid substance (defined as a liquid, gel or paste) which is a horizontal form-fill-seal (HFFS) envelope. These packages comprise a body wall portion having internal volume and which is preferably dome-shaped, formed from a first sheet, and a superposed base wall portion, formed from a second sheet, seded to the body wall portion.

A PVOH package containing a liquid laundry detergent composition comprising from about 10% to about 24% by weight of water (but 3.57% in the sole example) is disclosed in U.S. Pat. No. 4,973,416.

When formulating a liquid unit dose product of the kind wherein a substantially non-aqueous formulation is encapsulated in a water soluble film, probably the most difficult challenge is to preserve the physical integrity and stability of the film. One approach to this problem is disclosed in our International Patent Application No. PCT/EP01/0377, which involves substantially neutralising, or over-neutralising any acidic components in the liquid composition, especially any fatty acids and/or acid precursors of anionic surfactant. However, this approach is specific to encapsulation using a water-soluble film based on PVOH which includes comonomer units having carboxyl functionality.

Preservation of the integrity of films which contain fabric softening compositions is particularly challenging since commercial softening compositions are generally aqueous and would thus tend to interact undesirably with water soluble packaging causing a weakening of the film and potentially premature breakage, e.g. during storage.

One way of addressing this problem is disclosed in U.S. Pat. No. 4,765,916 which involves providing a cross-linked polymeric water soluble film. Although fabric softeners are mentioned, the only disclosure and example is of solid fabric softeners.

However, it is desirable to provide a liquid rinse conditioning composition within a water soluble package since this provides a more aesthetically pleasing product for consumers as well as a product providing a desirable tactile sensation. Furthermore, a rinse conditioner already in liquid form only requires dispersion for use whereas a solid composition must dissolve prior to dispersing. Therefore, a liquid composition is likely to provide excellent spreading of the softener throughout the rinse and onto the fabrics being treated.

There is no provision for such a package in U.S. Pat. No. 4,765,916.

### OBJECT OF THE INVENTION

The present invention seeks to address one or more of the above-mentioned problems and provide one or more of the above-mentioned benefits.

### SUMMARY OF THE INVENTION

The present invention provides a water soluble package and a substantially non-aqueous liquid rinse conditioning composition therein, wherein the water soluble package comprises a polymeric film.

According to the invention, there is also provided a process for conditioning fabrics comprising the step of adding to the rinse cycle of a washing operation the above-mentioned water soluble package and rinse conditioning composition therein, allowing or causing the package to break so as to release the contents therefrom and contacting the composition with fabric being laundered, wherein the package is disposed either in the rinse compartment of the dispenser drawer or in the drum at the end of the wash cycle, at the beginning of the rinse cycle or at any time therebetween, and disperses and/or dissolves immediately.

The invention further provides a process for conditioning fabrics comprising the step of adding to the rinse cycle of a washing operation the water soluble package and rinse conditioning composition therein, allowing or causing the package to break so as to release the contents therefrom and contacting the composition with fabric being laundered, wherein the package is disposed in the drum at the beginning of the wash cycle, remains substantially intact during the wash cycle and disperses and/or dissolves at the beginning of or during the rinse cycle.

### DETAILED DESCRIPTION OF THE INVENTION

The invention relates to a water soluble package comprising a non-aqueous liquid rinse conditioner therein.

In one embodiment the invention provides a water soluble package and a substantially non-aqueous liquid rinse conditioning composition therein, wherein the water soluble package comprises an immediate release polymeric film.

In a second embodiment the invention provides a water soluble package and a substantially non-aqueous liquid rinse conditioning composition therein, wherein the water soluble package comprises delayed release polymeric film.

The water soluble package and the contents therein must be compatible with each other. By “compatible” is meant that in an inert atmosphere free of moisture and at a temperature of from 5 to 40° C., the water soluble package with the rinse conditioner contents therein does not rupture or release any contents within the first 4 weeks.

### The Water Soluble Package

Any water soluble film forming polymer which is compatible with formulations defined below for use in the invention can be employed in the present invention.

Preferably the water soluble film is either an immediate release or a delayed release film.

“Immediate release” is defined herein as a package which, when placed in the rinse compartment of the dispenser drawer or in the drum of a top loading washing machine drum at the end of the wash cycle, dissolves and/or disperses in less than 10 minutes in water at 1-25° C., more preferably less than 7 minutes, most preferably less than 5 minutes, e.g. less than 2 minutes.

“Delayed release” is defined herein as a package which, when placed in the drum at the beginning of the wash cycle, remains substantially intact (as defined below) during the wash cycle and then disperses or dissolves at the beginning of or during the rinse cycle.

A trigger source which activates or accelerates dispersal or dissolution of the water soluble package once the rinse cycle commences is desirably present. Suitable trigger sources include, for instance, sources/materials for causing changes in pH, temperature, electrolytic conditions, light, time or molecular structure. The triggers may be used alone or in combination with each other.

The rinse conditioner formulation itself may also be designed so as to aid and/or control the dissolution or and/or dispersion of the package.

### The Water Soluble Polymer Film

Preferred water soluble polymers are those capable of being cast into a film or solid mass and may for example as described in Davidson and Sittig, Water-Soluble Resins, Van Nostrand Reinhold Company, New York (1968). The water-soluble polymer should have proper characteristics, such as strength and pliability, to permit machine handling. Preferred water-soluble resins include PVOH, cellulose ethers, polyethylene oxide (hereinafter referred to as “PEO”), starch, polyvinylpyrrolidone (hereinafter referred to as “PVP”), polyacrylamide, polyvinyl methyl ether-maleic anhydride, polymaleic anhydride, styrene maleic anhydride, hydroxyethylcellulose, methylcellulose, polyethylene glycols, carboxymethylcellulose, polyacrylic acid salts, alginates, acrylamide copolymers, guar gum, casein, ethylene-maleic anhydride resin series, polyethyleneimine, ethyl hydroxyethylcellulose, ethyl methylcellulose, hydroxyethyl methylcellulose. Lower molecular weight water-soluble, PVOH film-forming resins are preferred.

Generally, preferred water-soluble, PVOH film-forming polymers should have relatively low average molecular weight and low levels of hydrolysis in water. Polyvinyl alcohols preferred for use therein have an average molecular weight between 1,000 and 300,000, preferably between 2,000 and 100,000, most preferably between 2,000 and 75,000. Hydrolysis, or alcoholysis, is defined as the percent completion of the reaction where acetate groups on the resin are substituted with hydroxyl, —OH, groups. A hydrolysis range of from 60-99% of PVOH film-forming resin is preferred, while a more preferred range of hydrolysis is from about 70-90% for water-soluble, PVOH film-forming resins. The most preferred range of hydrolysis is 80-88%. As used in this application, the term “PVOH” includes polyvinyl acetate compounds with levels of hydrolysis disclosed herein.

If the polymer is of the delayed release type, it is preferred that the water-soluble resin film should be formulated so as to remain substantially intact during the main wash cycle of the washing machine operation and to substantially completely dissolve in water at the beginning of or during the rinse cycle.

In the context of the present invention, “substantially intact” means that the film may dissolve or disperse partially but the contents thereof remain wholly within the film.

All of the above polymers include the aforementioned polymer classes whether as single polymers or as copolymers formed of monomer units or as copolymers formed of monomer units derived from the specified class or as copolymers wherein those monomer units are copolymerised with one or more comonomer units.

A preferred plastics film is a PVOH film, especially one made of a PVOH copolymer having a comonomer having a carboxylate function.

PVOH can be made by the polymerisation of vinyl acetate, followed by hydrolysis, conveniently by reaction with sodium hydroxide. However, the resulting film has a highly symmetrical, hydrogen-bonded structure and is not readily soluble in cold water. PVOH films which are suitable for the formation of water soluble packages are typically polymers produced from copolymerisation of vinyl acetate and another comonomer which contains a carboxylic function. Examples of such comonomers include monocarboxylates, such as acrylic acid, and dicarboxylates, such as itaconic acid, which may be present during polymerisation as esters. Alternatively, the anhydride of maleic acid may be used as the copolymer. The inclusion of the comonomer reduces the symmetry of and degree of hydrogen bonding in the final film and renders the film soluble even in cold water.

Suitable PVOH films for use in a package according to the invention are commercially available and described, for example, in, EP-B-0 291 198. PVOH films for use in a package according to the invention can be made by the copolymerisation of vinyl acetate and a carboxylate-containing monomer (for example acrylic, maleic or itaconic acid or acid ester), followed by partial (for example up to about 90%) hydrolysis with sodium hydroxide.

### Cross-linking

In order to provide a water soluble package which maintains integrity and structure during the wash cycle but which dissolves or disperses fully in the rinse cycle, it has been found advantageous for the water soluble film to be provided as a cross-linked polymeric structure.

Particularly suitable cross-linking agents include formaldehyde; polyesters; epoxides, amidoamines, anhydrides, phenols; isocyanates; vinyl esters; urethanes; polyimides; arylics; bis(methacrylkoxypropyl) tetramethylsiloxane (styrenes, methylmethacrylates); n-diazopyruvates; phenyboronic acids; cis-platin; divinylbenzene; polyamides; dialdehydes; triallyl cyanurates; N-(-2-ethanesulfonylethyl)pyridinium halides; tetraalkyltitanates; mixtures of titanates and borates or zirconates; polyvalent ions of Cr, Zr, Ti; dialdehydes, diketones; alcohol complexes of organotitanates, zircoates and borates and copper (II) complexes.

Most preferred as the cross-linking agent is boric acid or its salt form, e.g. sodium borate.

Levels of cross-linking agent are dictated primarily by the physical parameters of the PVOH film layer, e.g., molecular weight, percent hydrolysis and thickness, and secondarily by the additive and wash conditions. The level of cross-linking agent, if present, is from about 0.05% to 9% by weight of the film, more preferably 1% to 6%, most preferably about 1.5% to 5% by weight. The upper range will, of course, result in more cross-linking and a slower rate of dissolution or dispersion of the film in the rinse cycle.

Functionally, it is believed that the cross-linking agent reduces the solubility of the film polymer by increasing its effective molecular weight. While it is preferred to incorporate the cross-linking agent directly into the film polymer, it is also within the scope of the invention to maintain the film in contact with the cross-linking agent during the wash. This may be done by adding the cross-linking agent to the wash solution, or by encasing it within the film polymer. If the cross-linking agent is added in this manner, somewhat higher levels are needed to sufficiently cross-link the film polymer, and should range from about 1-15% by weight.

For PVOH films, the preferred cross-linking agent is a metalloid oxide such as borate, tellurate, arsenate, and precursors thereof. Other known cross-linkers are selected from a vanadyl ion, a titanium ion in the plus three valence state, or a permanganate ion (disclosed in patent U.S. Pat. No. 3,518,242). Other cross-linkers are given in the book: Polyvinylalcohol—Properties and applications, Chapter 9 by C. A. Finch (John Wiley & Sons, New York, 1973). The cross-linking agent can be present in the film itself and/or in the wash solution.

For immediate release packages, it is desired that the film does not remain substantially intact over the wash cycle period and so a cross-linking agent is generally not required. Therefore, for an immediate release package, the film may be substantially, if not entirely, free of cross-linking agent.

### Plasticiser

The film preferably incorporates a plasticiser.

As will be described in more detail below, the water soluble film may be formed from a variety of different materials. The plasticiser will depend on the nature of the film in question. Therefore, preferred plasticisers will be recited in more detail in the section of this description dealing with these film materials. However, the preferred amount of plasticiser is from 0.001% to 10%, preferably from 0.005% to 4% by weight of the substantially non-aqueous liquid composition. One or more plasticisers may independently be incorporated in the film and in the liquid composition. However, it is very much preferred for the identity of the plasticiser(s) in the film and in the liquid composition to be substantially the same.

The plasticiser system influences the way the polymer chains react to external factors such as compression and extensional forces, temperature and mechanical shock by controlling the way that the chains distort/realign as a consequences of these intrusions and their propensity to revert or recover to their former state. The key feature of plasticisers is that they are highly compatible with the film, and are normally hydrophilic in nature.

Generally, plasticisers suitable for use with PVOH-based films have —OH groups in common with the —CH2—CH(OH)—CH2—CH(OH)— polymer chain of the film polymer.

Their mode of functionality is to introduce short chain hydrogen bonding with the chain hydroxyl groups and this weakens adjacent chain interactions which inhibits swelling of the aggregate polymer mass—the first stage of film dissolution.

Water itself is a suitable plasticiser for PVOH films but other common plasticisers include:

Polyhydroxy compounds, e.g. glycerol, trimethylolpropane, diethylene glycol, triethylene glycol, dipropylene glycol; starches, e.g. starch ether, esterificated starch, oxidized starch and starches from potato, tapioca and wheat; cellulosics/carbohydrates, e.g. amylopectin, dextrin carboxymethylcelluose and pectin; PVP, another preferred polymer for use in the articles of the present invention, which may be cast from a variety of solvents to produce films which are clear, glossy, and reasonably hard at low humidities.

PVP films exhibit excellent adhesion to a wide variety of surfaces, including glass, metals, and plastics. Unmodified films of polyvinylpyrrolidone are hygroscopic in character. Dry polyvinylpyrrolidone film has a density of 1.25 g.cm⁻³ and a refractive index of 1.53. Tackiness at higher humidities may be minimized by incorporating compatible, water-insensitive modifiers into the polyvinylpyrrolidone film, such as 10% of an aryl-sulfonamide-formaldehyde resin.

Suitable plasticisers for PVP-based films may be chosen from one or more of:

phosphates e.g. tris(2-ethylhexyl)phosphate, isopropyl diphenyl phosphate, tributoxyethylphosphate; polyols e.g. glycerol, sorbitol, diethylene glycol diperlargonate, polyethylene glycol di-2-ethylhexanoate, dibutyl tartrate; polyol esters e.g. hydroxy containing polycaprolactones, hydroxy containing poly-L-lactide; lower phthalates e.g. dimethyl phthalate, diethyl phthalate, dibutyl pthalate; and sulfonamides e.g. toluene sulfonamide, N-ethyltoluene sulfonamide.

Preferred water-soluble films may also be prepared from polyethylene oxide (PEO) resins by standard moulding techniques such as calendering, casting, extrusion, and other conventional techniques. The polyethylene oxide films may be clear or opaque, and are inherently flexible, tough, and resistant to most oils and greases. These polyethylene oxide resin films provide better solubility than other water-soluble plastics without sacrificing strength or toughness. The excellent ability to lay flat, stiffness, and sealability of water-soluble polyethylene oxide films make for good machine handling characteristics.

Suitable plasticisers for PEO-based films may be selected from one or more of:

phosphates e.g. tris(2-ethylhexyl)phosphate, isopropyl diphenyl phosphate, tributoxyethylphosphate; polyols e.g. glycerol, sorbitol, diethylene glycol diperlargonate, polyethylene glycol di-2-ethylhexanoate, dibutyl tartrate; lower phthalates e.g. dimethyl phthalate, diethyl phthalate, dibutyl pthalate; and sulfonamides e.g. toluene sulfonamide, N-ethyltoluene sulfonamide.

### Additional Protective Layers

If a protective layer such as PTFE is present between the film polymer and the rinse conditioner composition, it is possible for the rinse conditioner composition to comprise higher levels of water. Although, not the subject of the present invention, it is noted that a water soluble film coated on the inside with PTFE, as disclosed in U.S. Pat. No. 4,416,791 is capable of maintaining structure and integrity even if it contains a composition having a level of water of 30% by weight or more, even 50% by weight or more.

### Encapsulation Methods

Any reference herein to filling refers to complete filling and also partial filling whereby some air or other gas is also trapped in the sealed envelope.

The envelope forming the package is preferably formed by horizontal or vertical form-film-seal technique.

### (a) Horizontal Form-Fill-Seal

Water soluble packages based on PVOH can be made according to any of the horizontal form-fill-seal methods described in any of WO-A-00/55044, WO-A-00/55045, WO-A-00/55046, WO-A-00/55068, WO-A-00/55069 and WO-A-00/55415.

By way of example, a thermoforming process is now described where a number of packages according to the invention are produced from two sheets of water soluble material. In this regard recesses are formed in the film sheet using a forming die having a plurality of cavities with dimensions corresponding generally to the dimensions of the packages to be produced. Further, a single heating plate is used for thermoforming the film for all the cavities, and in the same way a single sealing plate is described.

A first sheet of PVOH film is drawn over a forming die so that the film is placed over the plurality of forming cavities in the die. In this example each cavity is generally dome shape having a round edge, the edges of the cavities further being radiussed to remove any sharp edges which might damage the film during the forming or sealing steps of the process. Each cavity further includes a raised surrounding flange. In order to maximise package strength; the film is delivered to the forming die in a crease free form and with minimum tension. In the forming step, the film is heated to 100 to 120° C., preferably approximately 110° C., for up to 5 seconds, preferably approximately 700 micro seconds. A heating plate is used to heat the film, which plate is positioned to superpose the forming die. During this preheating step, a vacuum of 50 kPa is pulled through the pre-heating plate to ensure intimate contact between the film and the pre-heating plate, this intimate contact ensuring that the film is heated evenly and uniformly (the extent of the vacuum is dependant of the thermoforming conditions and the type of film used, however in the present context a vacuum of less than 0.6 kPa was found to be suitable). Non-uniform heating results in a formed package having weak spots. In addition to the vacuum, it is possible to blow air against the film to force it into intimate contact with the preheating plate.

The thermoformed film is moulded into the cavities blowing the film off the heating plate and/or by sucking the film into the cavities thus forming a plurality of recesses in the film which, once formed, are retained in their thermoformed orientation by the application of a vacuum through the walls of the cavities. This vacuum is maintained at least until the packages are sealed. Once the recesses are formed and held in position by the vacuum, a liquid composition according to the invention is added to each of the recesses. A second sheet of polyvinyl alcohol film is then superposed on the first sheet across the filled recesses and heat-sealed thereto using a sealing plate. In this case the heat sealing plate, which is generally flat, operates at a temperature of about 140 to 160° C., and contacts the films for 1 to 2 seconds and with a force of 8 to 30 kg/cm², preferably 10 to 20 kg/cm². The raised flanges surrounding each cavity ensure that the films are sealed together along the flange to form a continuous seal. The radiussed edge of each cavity is at least partly formed by a resiliently deformable material, such as for example silicone rubber. This results in reduced force being applied at the inner edge of the sealing flange to avoid heat/pressure damage to the film.

Once sealed, the packages formed are separated from the web of sheet film using cutting means. At this stage it is possible to release the vacuum on the die, and eject the formed packages from the forming die. In this way the packages are formed, filled and sealed while nesting in the forming die. In addition they may be cut while in the forming die as well.

During the forming, filling and sealing steps of the process, the relative humidity of the atmosphere is controlled to ca. 50% humidity. This is done to maintain the heat sealing characteristics of the film. When handling thinner films, it may be necessary to reduce the relative humidity to ensure that the films have a relatively low degree of plasticisation and are therefore stiffer and easier to handle.

### (b) Vertical Form-Fill-Seal

In the vertical form-fill-seal (VFFS) technique, a continuous tube of flexible plastics film is extruded. It is sealed, preferably by heat or ultrasonic sealing, at the bottom, filled with the liquid composition, sealed again above the liquid film and then removed from the continuous tube, e.g. by cutting.

Encapsulation methods for other water soluble films such as based on PVP or PEO will be known to those skilled in the art.

### Unit Dose Volume

The amount of the substantially non-aqueous liquid product in each unit dose package may for example be from 0.5 ml to 100 ml, e.g. from 1 ml to 30 ml, preferably from 1.5 ml to 25 ml, more preferably from 2 ml to 15 ml.

### Rinse Conditioning Composition

The water soluble package contains a liquid rinse conditioning composition.

It is essential that the rinse conditioning composition is substantially non-aqueous so as to be compatible with the immediate release water soluble polymeric film.

Furthermore, it is essential that the rinse conditioner can dissolve and/or disperse rapidly once it is released from the package.

In the context of the present invention, “rapidly” in relation to dispersal and/or dissolution of the rinse conditioner composition means within 20 minutes, more preferably less than 15 minutes, most preferably less than 12 minutes, e.g. less than 10 minutes in water at 25° C. or less.

In the context of the present invention, “substantially non-aqueous” means that the level of water or other aqueous components in the rinse conditioner composition is less than 20% by weight of the total weight of the rinse conditioner composition, more preferably 15% or less by weight, most preferably 10%, e.g. 5% of even 3% or less by weight.

Compositions which are compatible with the water soluble film and which dissolve and/or disperse rapidly in cold water include the following:

Substantially non-aqueous concentrated melts, concentrated emulsions and microemulsions.

For the purposes of the present invention, a substantially non-aqueous concentrated melts is defined as a fabric conditioning composition present in solid form, such as particles, at a specified temperature, the solid being suspended in an oil matrix and containing less than 20 wt %, preferably less than 5 wt % of water.

A substantially non-aqueous concentrated rinse conditioner emulsion is defined as a mixture of a quaternary ammonium softening material, an oil and water comprising more than 10 wt % of the quaternary ammonium material and less than 20 wt % of water.

A substantially non-aqueous microemulsion is defined as a composition comprising less than 20% by weight water, wherein the composition is clear, isotropic and thermodynamically stable across a range of temperatures.

The following conventional ingredients are optionally present in the compositions rinse conditioner compositions compatible with the packages used in the invention.

### Cationic Fabric Softening Compound

The fabric softening compound is selected from those typically included in rinse-added fabric softening compositions.

It is especially preferred if the cationic softening agent is a water insoluble quaternary ammonium material which comprises a compound having two C₁₂₋₁₈ alkyl or alkenyl groups connected to the nitrogen head group via at least one ester link. It is more preferred if the quaternary ammonium material has two ester links.

A first preferred type of ester-linked quaternary ammonium material is represented by formula (I):

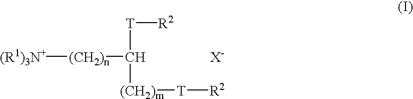

wherein T is

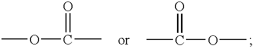

each R¹ group is independently selected from C₁₋₄, alkyl or hydroxyalkyl or C₂₋₄ alkenyl groups; and wherein each R² group is independently selected from C₈₋₂₈ alkyl or alkenyl groups; X⁻ is any suitable anion including a halide, acetate or lower alkosulphate ion, such as chloride or methosulphate, n is 0 or an integer from 1 to 5, and m is an integer from 1 to 5.

Preferred materials of this class such as 1,2 bis[hardened tallowoyloxy]-3- trimethylammonium propane chloride and their method of preparation are, for example, described in U.S. Pat. No. 4,137,180 (Lever Brothers). Preferably these materials comprise small amounts of the corresponding monoester as described in U.S. Pat. No. 4,137,180 for example 1-hardened tallowoyloxy -2-hydroxy 3-trimethylammonium propane chloride.

A second type of ester-linked quaternary ammonium material is represented by the formula (II):

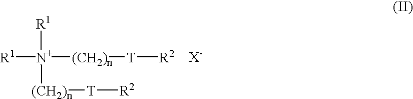

wherein T, R¹, R², n, and X⁻ are as defined above.

Especially preferred materials within this formula are di-alkenyl esters of triethanol ammonium methyl sulphate and N-N-di(tallowoyloxy ethyl) N,N-dimethyl ammonium chloride. Commercial examples of compounds within this formula are Tetranyl® AOT-1 (di-oleic ester of triethanol ammonium methyl sulphate 80% active), AO-1(di-oleic ester of triethanol ammonium methyl sulphate 90% active), AHT-1 (di-hardened oleic ester of triethanol ammonium methyl sulphate 90% active), L1/90 (partially hardened tallow ester of triethanol ammonium methyl sulphate 90% active), L5/90 (palm ester of triethanol ammonium methyl sulphate 90% active (supplied by Kao corporation) and Rewoquat WE15 (C₁₀-C₂₀ and C₁₆-C₁₈ unsaturated fatty acid reaction products with triethanolamine dimethyl sulphate quaternised 90% active), ex. Witco Corporation.

A third preferred type of quaternary ammonium material is represented by formula (III):

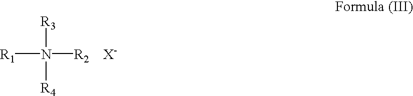

where R₁ and R₂ are C₈₋₂₈ alkyl or alkenyl groups; R₃ and R₄ are C₁₋₄ alkyl or C₂₋₄ alkenyl groups and X⁻ is as defined above.

Examples of compounds within this formula include di(tallow alkyl)dimethyl ammonium chloride, di(tallow alkyl) dimethyl ammonium methyl sulphate, dihexadecyl dimethyl ammonium chloride, di(hardened tallow alkyl) dimethyl ammonium chloride, dioctadecyl dimethyl ammonium chloride and di(coconut alkyl) dimethyl ammonium chloride.

It is advantageous for environmental reasons if the quaternary ammonium material is biologically degradable.

Preferably, the compositions are provided as superconcentrates comprising from 25-97% by weight of cationic surfactant (active ingredient) based on the total weight of the composition, more preferably 35-95% by weight, most preferably 45-90% by weight, e.g. 55-85% by weight.

If the quaternary ammonium softening agent comprises hydrocarbyl chains formed from fatty acids or fatty acyl compounds which are unsaturated or at least partially unsaturated (e.g. having an iodine value of from 5 to 140, preferably 5 to 100, more preferably 5 to 60, most preferably 5 to 40, e.g. 5 to 25), then the cis:trans isomer weight ratio in the fatty acid/fatty acyl compound is greater than 20:80, preferably greater than 30:70, more preferably greater than 40:60, most preferably greater than 50:50, e.g. 70:30 or greater. It is believed that higher cis:trans isomer weight ratios afford the compositions comprising the compound better low temperature stability and minimal odour formation. Suitable fatty acids include Radiacid 406, ex. Fina.

Saturated and unsaturated fatty acids/acyl compounds may be mixed together in varying amounts to provide a compound having the desired iodine value.

Fatty acids/acyl compounds may also be, at least partially hydrogenated to achieve lower iodine values.

Of course, the cis:trans isomer weight ratios can be controlled during hydrogenation by methods known in the art such as by optimal mixing, using specific catalysts and providing high H₂ availability.

For improved rapid dispersion and/or dissolution of the composition after its release from the water soluble package, it is preferred that the fatty acyl compounds or fatty acids from which the softening compound is formed have an iodine value of from 5 to 140, more preferably 10 to 100, most preferably 15 to 80, e.g. 25 to 60.

### Iodine Value of the Parent Fatty Acid

In the context of the present invention, iodine value of the parent fatty acid of the cationic surfactant is defined as the number of grams of iodine which react with 100 grams of compound.

To calculate the iodine value of a parent fatty acid of a cationic surfactant, a prescribed amount (from 0.1-3 g) of the fatty acid was dissolved into about 15 ml chloroform. The dissolved parent fatty acid was then reacted with 25 ml of iodine monochloride in acetic acid solution (0.1 M). To this, 20 ml of 10% potassium iodide solution and about 150 ml deionised water was added. After addition of the halogen to the parent fatty acid had taken place, the excess of iodine monochloride was determined by titration with sodium thiosulphate solution (0.1 M) in the presence of a blue starch indicator powder. At the same time a blank was determined with the same quantity of reagents and under the same conditions. The difference between the volume of sodium thiosulphate used in the blank and that used in the reaction with the parent fatty acid enabled the iodine value to be calculated.

### Oily Sugar Derivatives

The rinse conditioner compositions may comprise an oily sugar derivative.

The oily sugar derivative is a liquid or soft solid derivative of a cyclic polyol or of a reduced saccharide, said derivative resulting from 35 to 100% of the hydroxyl groups in said polyol or in said saccharide being esterified or etherified. The derivative has two or more ester or ether groups independently attached to a C₈-C₂₂ alkyl or alkenyl chain.

The oily sugar derivative is also referred to herein as “derivative-CP” and “derivative-RS” dependant upon whether the derivative is the product derived from a cyclic polyol or from a reduced saccharide starting material respectively.

Preferably the derivative-CP and derivative-RS contain 35% by weight tri or higher esters, e.g. at least 40%.

Preferably 35 to 85% most preferably 40 to 80%, even more preferably 45 to 75%, such as 45 to 70% of the hydroxyl groups in said cyclic polyol or in said reduced saccharide are esterified or etherified to produce the derivative-CPE and derivative-RSE respectively.

For the derivative-CP and derivative-RS, the tetra, penta etc prefixes only indicate the average degrees of esterification or etherification. The compounds exist as a mixture of materials ranging from the monoester to the fully esterified ester. It is the average degree of esterification as determined by weight that is referred to herein.

The derivative-CP and derivative-RS used do not have any substantial crystalline character at 20° C. Instead they are preferably in a liquid or soft solid state, as hereinbelow defined, at 20° C.

The starting cyclic polyol or reduced saccharide material is esterified or etherified with C₈-C₂₂ alkyl or alkenyl chains to the appropriate extent of esterication or etherification so that the derivatives are in the requisite liquid or soft solid state. These chains may contain unsaturation, branching or mixed chain lengths.

Typically the derivative-CP and derivative-RS has 3 or more, preferably 4 or more, for example 3 to 8, e.g. 3 to 5, ester or ether groups or mixtures thereof. It is preferred if two or more of the ester or ether groups of the derivative-CP and derivative-RS are independently of one another attached to a C₈ to C₂₂ alkyl or alkenyl chain. The alkyl or alkenyl groups may be branched or linear carbon chains.

The derivative-CPs are preferred for use as the oily sugar derivative. Inositol is a preferred cyclic polyol, and Inositol derivatives are especially preferred.

In the context of the present invention the terms derivative-CP and derivative-RS encompass all ether or ester derivatives of all forms of saccharides which fall into the above definition, which are especially preferred for use. Examples of preferred saccharides for the derivative-CP and derivative-RS to be derived from are monosaccharides and disaccharides.

Examples of monosaccharides include xylose, arabinose, galactose, fructose, sorbose and glucose. Glucose is especially preferred. An example of a reduced saccharide is sorbitan. Examples of disaccharides include maltose, lactose, cellobiose and sucrose. Sucrose is especially preferred.

If the derivative-CP is based on a disaccharide it is preferred if the disaccharide has 3 or more ester or ether groups attached to it. Examples include sucrose tri, tetra and penta esters.

Where the cyclic polyol is a reducing sugar it is advantageous if each ring of the derivative-CP has one ether group, preferably at the C₁ position. Suitable examples of such compounds include methyl glucose derivatives.

Examples of suitable derivative-CPs include esters of alkyl(poly)glucosides, in particular alkyl glucoside esters having a degree of polymerisation from 1 to 2.

The HLB of the derivative-CP and derivative-RS is typically between 1 and 3.

The derivative-CP and derivative-RS may have branched or linear alkyl or alkenyl chains (of varying degrees of branching), mixed chain lengths and/or unsaturation. Those having unsaturated and/or mixed alkyl chain lengths are preferred.

One or more of the alkyl or alkenyl chains (independently attached to the ester or ether groups) may contain at least one unsaturated bond.

For example, predominantly unsaturated fatty chains may be attached to the ester/ether groups, e.g. those attached may be derived from natural oils such as rapeseed oil, cotton seed oil and soybean oil; or natural fatty acids such as, oleic acid, tallow fatty acid, palmitoleic acid, linoleic acid, erucic acid or other sources of unsaturated vegetable fatty acids.

The alkyl or alkenyl chains of the derivative-CP and derivative-RS are preferably predominantly unsaturated, for example sucrose tetratallowate, sucrose tetrarapeate, sucrose tetraoleate, sucrose tetraesters of soybean oil or cotton seed oil, cellobiose tetraoleate, sucrose trioleate, sucrose triapeate, sucrose pentaoleate, sucrose pentarapeate, sucrose hexaoleate, sucrose hexarapeate, sucrose triesters, pentaesters and hexaesters of soybean oil or cotton seed oil, glucose trioleate, glucose tetraoleate, xylose trioleate, or sucrose tetra-,tri-, penta- or hexa-esters with any mixture of predominantly unsaturated fatty acid chains.

However some derivative-CPs and derivative-RSs can be based on polyunsaturated fatty acid derived alkyl or alkenyl chains, e.g. sucrose tetralinoleate. However, it is preferred that most, if not all of the polyunsaturation has been removed by partial hydrogenation if such polyunsaturated fatty acids are used.

The most highly preferred liquid derivative-CP and derivative-RS are any of those mentioned in the above three paragraphs but where the polyunsaturation has been removed through partial hydrogenation.

Preferably 40% or more of the chains contain an unsaturated bond, more preferably 50% or more, most preferably 60% or more e.g. 65% 95% by number of the chains are unsaturated.

Oily sugar derivatives particularly suitable for use in the compositions include sucrose pentalaurate, sucrose tetraoleate, sucrose pentaerucate, sucrose tetraerucate, and sucrose pentaoleate. Suitable materials include some of the Ryoto series available from Mitsubishi Kagaku Foods Corporation.

The liquid or soft solid derivative-CP and derivative-RS are characterised as materials having a solid:liquid ratio of between 50:50 and 0:100 at 20° C. as determined by T₂ relaxation time NMR, preferably between 43:57 and 0:100, most preferably between 40:60 and 0:100, such as, 20:80 and 0:100. The T₂ NMR relaxation time is commonly used for characterising solid:liquid ratios in soft solid products such as fats and margarines. For the purpose of the present invention, any component of the NMR signal with a T₂ of less than 100 microsecond is considered to be a solid component and any component with T₂ greater than 100 microseconds is considered to be a liquid component.

The liquid or soft solid derivative-CPE and derivative-RSE can be prepared by a variety of methods well known to those skilled in the art. These methods include acylation of the cyclic polyol or of a reduced saccharide with an acid chloride; trans-esterification of the cyclic polyol or of a reduced saccharide material with short chain fatty acid esters in the presence of a basic catalyst (e.g. KOH); acylation of the cyclic polyol or of a reduced saccharide with an acid anhydride, and, acylation of the cyclic polyol or of a reduced saccharide with a fatty acid. Typical preparations of these materials are disclosed in U.S. Pat. No. 4,386,213 and AU 14416/88 (Procter and Gamble).

The rinse conditioner composition may comprise from 0.5%-90 wt % of the oily sugar derivatives, more preferably 5-80 wt %, most preferably 10-60 wt %, based on the total weight of the composition.

### Formulation and Dispersion Aids

The formulation aid is substantially non-aqueous and comprises one or more of the following components:

(a) nonionic stabilising agents;

(b) polymeric compounds having at least 2% by weight of water soluble groups either within the main polymer backbone or pendant thereto.

(c) single long hydrocarbyl chain cationic surfactants;

(d) long chain fatty alcohols or acids;

(e) short chain alcohols or oils; or

(f) inorganic and/or organic electrolytes

### Nonionic Stabilising Agents

The nonionic stabilising agents suitable for use in the rinse conditioner compositions include any of the alkoxylated materials of the particular type described hereinafter can be used as the nonionic surfactant.

Substantially water soluble surfactants of the general formula:

R—Y—(C₂H₄O)_{z}—C₂H₄OH

where R is selected from the group consisting of primary, secondary and branched chain alkyl and/or acyl hydrocarbyl groups; primary, secondary and branched chain alkenyl hydrocarbyl groups; and primary, secondary and branched chain alkenyl-substituted phenolic hydrocarbyl groups; the hydrocarbyl groups having a chain length of from 8 to about 25, preferably 10 to 20, e.g. 14 to 18 carbon atoms.

In the general formula for the ethoxylated nonionic surfactant, Y is typically:

—O—, —C(O)O—, —C(O)N(R)— or —C(O)N(R)R—

in which R has the meaning given above or can be hydrogen; and Z is at least about 8, preferably at least about 10 or 11.

Preferably the nonionic surfactant has an HLB of from about 7 to about 20, more preferably from 10 to 18, e.g. 12 to 16.

Examples of nonionic surfactants follow. In the examples, the integer defines the number of ethoxy (EO) groups in the molecule.

### A. Straight-Chain, Primary Alcohol Alkoxylates

The deca-, undeca-, dodeca-, tetradeca-, and pentadecaethoxylates of n-hexadecanol, and n-octadecanol having an HLB within the range recited herein are useful viscosity/dispersibility modifiers in the context of this invention. Exemplary ethoxylated primary alcohols useful herein as the viscosity/dispersibility modifiers of the compositions are C₁₈ EO(10); and C₁₈ EO(11). The ethoxylates of mixed natural or synthetic alcohols in the “tallow” chain length range are also useful herein. Specific examples of such materials include tallow alcohol-EO(11), tallow alcohol-EO(18), and tallow alcohol-EO (25).

### B. Straight-Chain, Secondary Alcohol Alkoxylates

The deca-, undeca-, dodeca-, tetradeca-, pentadeca-, octadeca-, and nonadeca-ethoxylates of 3-hexadecanol, 2-octadecanol, 4-eicosanol, and 5-eicosanol having an HLB within the range recited herein are useful viscosity and/or dispersibility modifiers in the context of this invention. Exemplary ethoxylated secondary alcohols useful herein as the viscosity and/or dispersibility modifiers of the compositions are: C₁₆ EO(11); C₂₀ EO(11); and C₁₆ EO(14).

### C. Alkyl Phenol Alkoxylates

As in the case of the alcohol alkoxylates, the hexa- to octadeca-ethoxylates of alkylated phenols, particularly monohydric alkylphenols, having an HLB within the range recited herein are useful as the viscosity and/or dispersibility modifiers of the instant compositions. The hexa- to octadeca-ethoxylates of p-tri-decylphenol, m-pentadecylphenol, and the like, are useful herein. Exemplary ethoxylated alkylphenols useful as the viscosity and/or dispersibility modifiers of the mixtures herein are: p-tridecylphenol EO(11) and p-pentadecylphenol EO(18).

As used herein and as generally recognized in the art, a phenylene group in the nonionic formula is the equivalent of an alkylene group containing from 2 to 4 carbon atoms. For present purposes, nonionics containing a phenylene group are considered to contain an equivalent number of carbon atoms calculated as the sum of the carbon atoms in the alkyl group plus about 3.3 carbon atoms for each phenylene group.

### D. Olefinic Alkoxylates

The alkenyl alcohols, both primary and secondary, and alkenyl phenols corresponding to those disclosed immediately hereinabove can be ethoxylated to an HLB within the range recited herein and used as the viscosity and/or dispersibility modifiers of the instant compositions.

### E. Branched Chain Alkoxylates

Branched chain primary and secondary alcohols which are available from the well-known “OXO” process can be ethoxylated and employed as the viscosity and/or dispersibility modifiers of compositions herein.

The above ethoxylated nonionic surfactants are useful in the present compositions alone or in combination, and the term “nonionic surfactant” encompasses mixed nonionic surface active agents.

The nonionic surfactant is present in an amount from 0.01 to 10%, more preferably 0.5 to 5%, most preferably 0.75 to 3.5%, e.g. 1 to 2% by weight, based on the total weight of the composition.

### Polymeric Compounds Having at Least 2% by Weight of Water Soluble Groups Either Within the Main Polymer Backbone or Pendant Thereto

Examples of suitable polymeric within this class include PVA; polylactones such as polycaprolactone and polylactide; methyl cellulose; derivativised starches; derivatives of cellulose; and cationic polymers such as Guar Gum.

If present, it is desirable to incorporate such polymers at a level of from 0.01 to 5%, more preferable 0.05 to 3.5%, most preferably from 1 to 2% by weight of the polymer based on the total weight of the composition.

### Single Long Hydrocarbyl Chain Cationic Surfactants

The compositions of the invention optionally contain a single long hydrocarbyl chain cationic surfactant.

The single long hydrocarbyl chain cationic surfactant are particularly suitable for use in emulsions since they can be employed in the formulation to aid the dispersion characteristics of the emulsion and/or to emulsify the composition, in order to form a macroemulsion having oil droplets which are smaller than those in macroemulsion compositions comprising the cationic fabric softening agent alone.

The single long chain cationic surfactant is preferably a quaternary ammonium compound comprising a hydrocarbyl chain having 8 to 40 carbon atom, more preferably 8 to 30, most preferably 12 to 25 carbon atoms (e.g. quaternary ammonium compounds comprising a C₁₀₋₁₈ hydrocarbyl chain are especially preferred).

Examples of commercially available single long hydrocarbyl chain cationic surfactants which may be used in the compositions of the invention include; ETHOQUAD (RTM) 0/12 (oleylbis(2-hydroxyethyl)methylammonium chloride); ETHOQUAD (RTM) C12 (cocobis(2-hydroxyethyl)methyl ammonium chloride) and ETHOQUAD (RTM) C25 polyoxyethylene(15)cocomethylammonium chloride), all ex. Akzo Nobel; SERVAMINE KAC (RTM), (cocotrimethylammonium methosulphate), ex. Condea; REWOQUAT (RTM) CPEM, (coconutalkylpentaethoxymethylammonium methosulphate), ex. Witco; cetyltrimethylammonium chloride (25% solution supplied by Aldrich); RADIAQUAT (RTM) 6460, (coconut oil trimethylammonium chloride), ex. Fina Chemicals; NORAMIUM (RTM) MC50, (oleyltrimethylammonium chloride), ex. Elf Atochem.

The single long hydrocarbyl chain cationic surfactant is preferably present in an amount from 0 to 5% by weight, more preferably 0.01 to 3% by weight, most preferably 0.5 to 2.5% by weight, based on the total weight of the composition.

### Long Chain Fatty Alcohols, Acids or Oils

The formulation aid may further be selected from fatty alcohols, acids or oils, for example C8 to C24 alkyl or alkenyl monocarboxylic acids, alcohols or polymers thereof and C₈ to C₃₅ oils. Preferably saturated fatty acids or alcohols are used, in particular, hardened tallow C₁₆ to C₁₈ fatty acids.

Preferably the fatty acid is non-saponified, more preferably the fatty acid is free, for example oleic acid, lauric acid or tallow fatty acid. The level of fatty acid material is preferably more than 0.1% by weight, more preferably more than 0.2% by weight. Concentrated and superconcentrated compositions may comprise from 0.5 to 20% by weight of fatty acid, more preferably 1% to 10% by weight.

Suitable fatty acids include stearic acid (PRIFAC 2980), myristic acid (PRIFAC 2940), lauric acid (PRIFAC 2920), palmitic acid (PRIFAC 2960), erucic acid (PRIFAC 2990), sunflower fatty acid (PRIFAC 7960), tallow acid (PRIFAC 7920), soybean fatty acid (PRIFAC 7951) all ex. Unichema; azelaic acid (EMEROX 1110) ex. Henkel.

The fatty acid may also act as a co-softener in the rinse conditioner composition.

The formulation aid may comprise a long chain oil. The oil may be a mineral oil, an ester oil, a silicone oil and/or natural oils such as vegetable or essential oils. However, ester oils or mineral oils are preferred.

The ester oils are preferably hydrophobic in nature. They include fatty esters of mono or polyhydric alcohols having from 1 to 24 carbon atoms in the hydrocarbon chain, and mono or polycarboxylic acids having from 1 to 24 carbon atoms in the hydrocarbon chain, provided that the total number of carbon atoms in the ester oil is equal to or greater than 8., and that at least one of the hydrocarbon chains has 12 or more carbon atoms.

Suitable ester oils include saturated ester oils, such as the PRIOLUBES (ex. Unichema). 2-ethyl hexyl stearate (PRIOLUBE 1545), neopentyl glycol monomerate (PRIOLUBE 2045) and methyl laurate (PRIOLUBE 1415) are particularly preferred although oleic monoglyceride (PRIOLUBE 1407) and neopentyl glycol dioleate (PRIOLUBE 1446) are also suitable.

It is preferred that the viscosity of the ester oil is from 0.002 to 0.4 Pa.S (2 to 400 cps) at a temperature of 25° C. at 106 s⁻¹, measured using a Haake rotoviscometer NV1, and that the density of the mineral oil is from 0.8 to 0.9 g.cm⁻³ at 25° C.

Suitable mineral oils include branched or straight chain hydrocarbons (e.g. paraffins) having 8 to 35, more preferably 9 to 20 carbon atoms in the hydrocarbon chain.

Preferred mineral oils include the Marcol technical range of oils (ex. Esso) although particularly preferred is the Sirius range (ex. Silkolene) or Semtol (ex. Witco Corp.). The molecular weight of the mineral oil is typically within the range 100 to 400.

One or more oils of any of the above mentioned types may be used.

It is believed that the oil provides excellent perfume delivery to the cloth and also increases perfume longevity upon storage of the composition.

The oil may be present in an amount from 0.1 to 40% by weight, more preferably 0.2-20%, by weight, most preferably 0.5-15% by weight based on the total weight of the composition.

### Short Chain Alcohols

The formulation aid may comprise a short chain alcohol. Preferred are low molecular weight alcohols having a molecular weight of preferably 180 or less. The alcohol may be mono or polyhydric.

The presence of the lower molecular weight alcohol helps improve physical stability upon storage by lowering the viscosity to a more desired level and also assists the formation of the micro-emulsion. Examples of suitable alcohols include ethanol, isopropanol, n-propanol, dipropylene glycol, t-butyl alcohol, hexylene glycol, and glycerol.

The alcohol is preferably present in an amount from 0.1% to 40% by weight, more preferably from 0.2% to 35%, most preferably 0.5 to 20% by weight based on the total weight of the composition.

### Inorganic And/Or Organic Electrolytes

The fabric softening composition optionally comprises an electrolyte.

The electrolyte may be an inorganic or organic electrolyte.

Preferably the electrolyte is present in an amount from 0.001 to 1.5%, more preferably 0.01 to 1%, most preferably 0.02 to 0.7% by weight based on the total weight of the composition.

Suitable inorganic electrolytes include sodium sulphate, sodium chloride, calcium(II) chloride, magnesium(II) chloride, potassium sulphate and potassium chloride.

Suitable organic electrolytes include sodium acetate, potassium acetate, sodium citrate, potassium citrate and sodium benzoate.

The electrolyte improves viscosity control (especially viscosity reduction) of the compositions and assists dispersion of the composition.

### Anti-Oxidation/Reduction Stabilisers

The compositions of the invention may, optionally, comprise one or more additional stabilisers which stabilise against oxidation and/or reduction.

If the stabilisers are present as anti-oxidants, they may be added at a level of from 0.005 to 2% by weight based on the total weight of the composition, more preferably from 0.01 to 0.2% by weight, most preferably from 0.035% to 0.1% by weight.

If present as an anti-reduction agent, then the stabiliser is preferably used in an amount from 0.001% to 0.2% by weight based on the total weight of the composition.

The stabilisers assist by assuring good odour stability upon storage particularly when the composition is prepared using a surfactant having substantial unsaturated character (i.e. type (a) surfactants as herein defined).

Typically, such additional stabilisers include mixtures of ascorbic acid, ascorbic palmitate and propyl gallate (under the tradenames Tenox® PG and Tenox® S-1); mixtures of butylated hydroxytoluene, butylated hydroxyanisole, propyl gallate and citric acid (under the tradename Tenox® 6); tertiary butylhydroquinone (under the tradename Tenox® TBHQ); natural tocopherols (under the tradenames Tenox® GT-1 and GT-2); long chain esters of gallic acid (under the tradenames Irganox® 1010, Irganox® 1035, Irganox® B 117 and Irganox® 1425) and mixtures thereof. Tenox products are supplied by Eastman Chemical Products Inc. Irganox products are supplied by Eastman Chemical Products Inc. The above stabilisers can also be mixed with chelating agents such as citric acid; 1-hydroxyethylidene-1,1-diphosphonic acid (Dequest® 2010, ex. Monsanto); 4,5-dihydroxy-m-benzene-sulphonic acid/sodium salt (under the tradename Tiron®, ex. Kodak) and diethylenetriaminepentaacetic acid (under the tradename DTPA®, ex. Aldrich).

### Co-active Softening Surfactants

Co-active softening surfactants for the cationic surfactant may also be incorporated in an amount from 0.01 to 20% by weight, more preferably 0.05 to 10%, based on the total weight of the composition. Preferred co-active softening surfactants are fatty amines and fatty N-oxides.

### Perfume

The perfume may be any perfume conventionally used in fabric softening compositions. The perfume will thus preferably be compatible with the types fabric softening actives typically found in fabric softening compositions, although, not many commercially available perfumes will not be compatible. Also the perfume will generally be polar in nature.

The perfume used in the invention may be lipophilic in nature. By a lipophilic perfume is meant that the perfume has a solubility in water (i.e. it dissolves) of 1 g or less in 100 ml of water at 20° C. Preferably solubility in water is 0.5 g or less, preferably 0.3 g or less. Such perfumes may be referred to as water-insoluble perfumes.

Perfumes contain a number of ingredients which may be natural products or extracts such as essential oils, absolutes, resinoids, resins etc. and synthetic perfume components such as hydrocarbons, alcohols, aldehydes, ketones ethers, acids, esters, acetals, ketals, nitrites, phenols, etc. including saturated and unsaturated compounds, aliphatic, alicyclic, heterocyclic and aromatic compounds.

Examples of such perfume components are to be found in “Perfume and Flavour Chemicals” by Steffen Arctander (Library of Congress catalogue card no. 75-91398).

When present, the perfume is used in a concentration of preferably from 0.01-20% by weight, more preferably from 0.05-17% by weight, most preferably from 1-10% by weight, e.g. 2 to 6% by weight based on the total weight of the composition.

### Crystal Growth Inhibitor

The rinse conditioner composition may include a crystal growth inhibitor. It is preferred that the crystal growth inhibitor forms part of the concentrate, particularly for non-batch dilution by the consumer at home.

The crystal growth inhibitors are compounds that have highly polarisable hydrophilic groups.

Particularly preferred crystal growth modifiers are organic acids of alkyl chain length C₁₃ or less and nonionic surfactants having an average alkyl chain length between C₁₃ and C₂₂ and from 10 to 30 ethoxylate groups. Particularly preferred crystal growth inhibitors are tallow and coco nonionic surfactants having from 15 to 22 ethoxylate groups, organic acids such as lactic acid (which contains about 20% linear polymeric self-esterified esters), stearic acid, and hardened or unhardened tallow or coco fatty acids. Mixtures of crystal growth inhibitors may also be used.

The crystal growth inhibitor or mixtures thereof should preferably be present at a level of from 1 wt % to 20 wt % based on the total weight of the rinse conditioner composition, more preferably 2 wt % to 11 wt % .

### Other Optional Ingredients

The compositions may also contain one or more optional ingredients conventionally included in fabric conditioning compositions such as pH buffering agents, perfume carriers, fluorescers, colourants, hydrotropes, antifoaming agents, antiredeposition agents, polyelectrolytes, enzymes, optical brightening agents, pearlescers, anti-shrinking agents, anti-wrinkle agents, anti-.spotting agents, germicides, fungicides, anti-corrosion agents, drape imparting agents, anti-static agents, ironing aids and dyes.

The rinse conditioner is substantially, and preferably entirely, free of anionic detergent surfactants conventionally used as an active cleaning ingredient in a main wash detergent product.

### Preparation of the Rinse Conditioner Composition

The compositions of the invention may be prepared according to any suitable method.

In a first method, a melt is prepared by heating a reaction vessel to at least 50° C., adding an oil and a nonionic surfactant to the vessel and stirring the mixture. A cationic surfactant and a fatty acid and/or a long or short chain alcohol and then added to the vessel, and the stirring rate is increased. Stirring is continued until a homogenous mixture is formed.

The mixture is then left to cool to ambient temperature, under continuous stirring. Optionally perfume and/or a polymeric structurant (such as disclosed in our co-pending application PCT/EP99/0049) is then stirred into the mixture.

In a second method, a microemulsion is prepared by mixing under low agitation an oil, a solvent such as a low molecular weight alcohol, a dispersibility aid such as a nonionic surfactant, a cationic surfactant and 10% by weight or less of water until a clear composition is formed. In order to assist formation of the clear microemulsion, the mixture may be heated as required. Perfume may optionally be added to the mixture at any stage.

In a third method, a concentrated emulsion is prepared by heating water to a temperature above 50° C., adding an emulsifier, premixing a cationic surfactant, nonionic surfactant and oil and adding this to the water. Optionally the product is milled and then allowed to cool. Once below 50° C., perfume may be added.

### Product Form

The water soluble package may be in the form of a capsule, or a polymeric matrix with the rinse conditioner composition therein, as long as the package comprises a polymeric film.

### Composition pH

When the composition is dispersed in water, the solution preferably has a pH of from 1.5 to 5.

### Product Use

In one method of use, the immediate release water soluble package is disposed in the rinse compartment of the dispenser drawer any time prior to the rinse cycle, or in the drum of a top loading washing machine at the end of the wash cycle, at the beginning of the rinse cycle or any time in between, so that the package dissolves and/or disperses immediately on contact with the water.

In another method of use, the delayed release water soluble package is disposed in the drum of the washing machine at the beginning of the wash cycle and only dissolves and/or disperses at the beginning of or during the rinse cycle.

### EXAMPLES

The invention will now be illustrated by the following non-limiting examples. Further modification within the scope of the present invention will be apparent to the person skilled in the art.

Examples of the invention are denoted by a number and comparative examples are denoted by a letter. All amounts are % by weight based on the total weight of the composition unless otherwise stated.

Compositions suitable for use in the packages of the present invention follow:

### Example 1

TABLE 1

| Ingredient | wt % |
|---|---|
| AOT-1 | 95 |
| Perfume | 5 |

AOT-1 is 80% Dioleyl Ester of Triethanol Amonium Methyl Sulphate in 20% Di-Propylene Glycol solvent (ex. Kao)

The composition was prepared by incorporating the perfume into the AOT-1 at room temperature under low shear mixing for about 5 minutes until a homogeneous emulsion is formed.

### Example 2

TABLE 2

| | |
|---|---|
| WE-15 | 90 |
| CocoEO5 | 5.5 |
| Perfume | 4.5 |

WE-15 is 90% Dioleyl Ester of Triethanol Amonium Methyl Sulphate in 10% IPA solvent (ex. Goldschmidt) CocoEO5 is a C12 alcohol with 5 ethoxylate groups (available as Genapol C050, ex. Clariant).

The compositions was prepared by the method described for the product in table 1.

### Example 3

A microemulsion composition suitable for use in the packages of the present invention is as follows:

TABLE 3

| | |
|---|---|
| AOT-1 | 32 |
| Coco5EO | 5 |
| Estol 1545 | 42 |
| Perfume B53 | 3 |
| Water | 10 |

Estol 1545 is 2-ethylhexyl stearate (ex. Uniqema)

The composition was prepared in the manner described above relating to microemulsion preparation.

### Example 4

A further microemulsion prepared as described above composition suitable for use in the packages of the present invention is as follows:

TABLE 4

| | |
|---|---|
| DEQA (IV 80) | 25 |
| Estol 1545 | 42 |
| Coco3EO | 5 |
| Perfume B53 | 3 |
| IPA | 3.8 |
| Water | 10 |
| Glycerol | 3.8 |

DEQA is 1,2-ditallowyloxy-3-N, N, N-trimethyl ammoniopropane chloride in a 6:1 weight ratio with IPA (ex. Clariant)

### Example 5

A further microemulsion composition suitable for use in the packages of the present invention is as follows:

TABLE 5

| | |
|---|---|
| L1/90 (IV 47) | 40 |
| Coco3EO | 5 |
| Estol 1545 | 42 |
| Perfume B53 | 3 |
| Water | 10 |

L1/90 is 90% Dipalm Ester of Triethanol Amonium Methyl Sulphate in 10% IPA solvent.

The composition was prepared in the manner described above for microemulsion preparation.

### Example 6

A further microemulsion composition suitable for use in the packages of the present invention is as follows:

TABLE 6

| | |
|---|---|
| AOT-1 | 26.5 |
| Coco3EO | 4.8 |
| Estol 1545 | 51.8 |
| Dipropylene glycol | 6.6 |
| Perfume B53 | 2 |

Coco 3EO is a C12 alcohol with 3 ethoxylate groups (available as Genapol C030, ex. Clariant).

The composition was prepared in the manner described above for microemulsion preparation.

### Example 7

A further microemulsion composition suitable for use in the packages of the present invention is as follows:

TABLE 7

| | |
|---|---|
| Arquad 2HT | 40 |
| Mineral oil: EMCA 70 | 30 |
| Neodol 91-6 | 4.3 |
| Perfume | 2.16 |
| Water | 13.54 |
| Isopropanol | 10 |

Arquad 2HT is di-hardened tallow di-methyl ammonium chloride (ex. Akzo Nobel) EMCA 70 is a branched mineral oil

The composition was prepared in the manner described above for microemulsion preparation.

### Example 8

A concentrated melt suitable for use in the packages of the present invention is as follows:

TABLE 8

| | |
|---|---|
| Arquad 2HT | 40 |
| Mineral oil: EMCA 70 | 40.5 |
| Neodol 91-6 | 4.3 |
| Perfume | 2.2 |
| Pristerine 4916 | 3 |
| Hexylene Glycol | 10 |

Neodol 91-6 is C9-11 fatty alcohol with 6 ethoxylate Groups (ex. Shell)

Pristerene 4916 is hardened tallow fatty acid (ex. Uniqema)

The composition was prepared as described above in relation to the preparation of concentrated melts.

### Example 9

A concentrated composition based on a primarily nonionic softening system suitable for use in the packages of the present invention is as follows:

TABLE 9

| | |
|---|---|
| Ryoto ER 290 (SPE) | 65 |
| Rewoquat WE-15 (Emulsifier) | 13.7 |
| Genapol C-050 | 5 |
| Propylene Glycol | 8.9 |
| Softline | 2.3 |
| Water | 6 |

Ryoto ER 290 is sucrose tetra-erucate (ex. Mitsubishi Foods).

The composition was prepared by adding all the ingredients together in a reaction vessel, heating the ingredients to 50° C. under low agitation until a clear composition forms and then allowing the composition to cool to ambient temperature.

### Example 10

Another concentrated composition based on a primarily nonionic softening system suitable for use in the packages of the present invention is as follows:

TABLE 10

| | |
|---|---|
| Ryoto ER 290 | 18.2 |
| Rewoquat WE-15 | 18 |
| Genapol C-050 | 5.5 |
| Propylene Glycol | 9.1 |
| Estol 1545 | 37.3 |
| Perfume | 2.9 |
| Water | 7 |

The composition was prepared in the manner described for the composition in table 9.

### Example 11

Another concentrated composition based on a primarily nonionic softening system suitable for use in the packages of the present invention is as follows:

TABLE 11

| | |
|---|---|
| Ryoto ER 290 | 70 |
| CTAB | 12 |
| Isopropyl alcohol | 13.4 |
| Perfume | 4.6 |

CTAB is Cetyl Tri-methyl Ammonium Bromide (ex. DanoChemo).

The composition was prepared in the manner described for the composition in table 9.

### Example 12

Another concentrated composition based on a primarily nonionic softening system suitable for use in the packages of the present invention is as follows:

TABLE 12

| | |
|---|---|
| Ryoto ER 290 | 73.5 |
| SDS | 12 |
| Tergitol 15-S-7 | 8.4 |
| Jaguar C 162 | 1.5 |
| Perfume | 1.7 |

SDS is Sodium Dodecyl Sulphate

Tergitol 15-s-7 is C11-15 secondary alcohol with 7 ethoxylate groups

Jaguar C162 is Gum Guar 2-hydroxy 3-(trimethylammonium) propylether chloride (ex. Rhodia)

The composition was prepared in the manner described for the composition in table 9.

25 ml of each of the compositions described in the examples above were then packaged in water soluble sachets made from M7030 grade PVOH film (76 micron thickness, supplied by Chris Craft).

Comparative examples of fabric softening compositions comprising more than 10 wt % of water are shown in tables 13 and 14.

### Example A

TABLE 13

| | |
|---|---|
| HEQ | 13% |
| Coco 20EO | 1% |
| Perfume | 1 |
| Water | To 100% |

Example A is an aqueous dispersion prepared by heating the water and the HEQ together and optionally stirring until a homogeneous mixture is formed, allowing the mixture to cool to below 40° C. and adding the perfume with mixing.

### Example B

TABLE 14

| | |
|---|---|
| Arquad 2HT/Accosoft 750 | 24 |
| Perfume | 1.5 |
| Water | To 100% |

Accosoft 750 is methyl bis (oleylamidoethyl) 2-hydroxyethyl ammonium methyl sulphate (ex. Stepan).

The aqueous dispersion was prepared by premixing the Arquad 2HT and Accosoft 750 and then following the method described for the composition in table 13.

These compositions were also packaged in the water soluble sachets made from M7030 grade PVOH film.

Upon storage for 4 weeks at room temperature, the package/contents of the invention clearly remained substantially intact whilst the package/comparative compositions ruptured and leaked contents therefrom.

1. A water soluble package comprising a substantially non-aqueous liquid rinse conditioning composition therein, wherein the water soluble package comprises a polymeric film.

2. A package and composition therein as claimed in claim 1 wherein the package is an immediate release package.

3. A package and composition therein as claimed in claim 1 wherein the package is a delayed release package.

4. A package and contents as defined in claim 3 wherein the polymeric film comprises 0.01 to 10% by weight of the package of a cross-linking agent.

5. A package and contents as defined in claim 1 wherein the rinse conditioning composition comprises a concentrated melt.

6. A package and contents as defined in claim 1 wherein the rinse conditioning composition comprises a concentrated emulsion.

7. A package and contents as defined in claim 1 wherein the rinse conditioning composition comprises a microemulsion.

8. A process for conditioning fabrics comprising the step of adding to the rinse cycle of a washing operation the water soluble package comprising a rinse conditioning composition therein as defined in claim 2, allowing or causing the package to break so as to release the contents therefrom and contacting the composition with fabric being laundered, wherein the package is disposed in the rinse compartment of the dispenser drawer prior to the rinse cycle or is disposed in the drum at the end of the wash cycle, at the beginning of the rinse cycle or at any time therebetween, and dissolves and/or disperses at the beginning of or during the rinse cycle.

9. A process for conditioning fabrics comprising the step of adding to the rinse cycle of a washing operation the water soluble package comprising a rinse conditioning composition therein as defined in claim 3, allowing or causing the package to break so as to release the contents therefrom and contacting the composition with fabric being laundered, wherein the package is disposed in the drum at the beginning of the wash cycle, remains substantially intact during the wash cycle and disperses and/or dissolves at the beginning of or during the rinse cycle.
